(19) United States
(12) Patent Application Publication
(10) Pub. No.: US 2004/0203563 A1
(43) Pub. Date: Oct. 14, 2004

(54) Emergency communication and monitoring system and method

(76) Inventor: Raymond J. Menard, Hastings, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/165,221

(22) Filed: Jun. 7, 2002

(51) Int. Cl. H04M 11/00

(52) U.S. Cl. 455/404.1; 455/406

(57) ABSTRACT

A system and method for pirating communication services of a nearby device for purposes of communicating an emergency request for assistance from a portable device. A user of the nearby device may or may not be aware of the surreptitious use of the communication services and such use is at reduced, or no cost, to the nearby device user. Location information corresponding to the portable device or a selected nearby device is provided to the monitor center. Database information, including contact data for an authorized guardian, is accessible to the monitor center or a public safety answering point (PSAP) facility.

### TECHNICAL FIELD

This invention relates generally to communication technology and particularly, but not by way of limitation, to a method of communicating emergency or monitoring information.

### BACKGROUND

Traditional cellular telephones, pagers and other wireless devices are able to communicate over great distances using a network of wireless transceivers or repeaters coupled to an existing network infrastructure. For example, a cellular telephone converts received audio to a wireless radio frequency(RF) signal that is received by a cellular antenna tower. The cellular antenna tower is coupled to a public switched telephone network (PSTN). Cellular telephone users are charged fees based on time of usage of the communication network.

What is needed is a system tailored to facilitate emergency communications.

### SUMMARY

This document discloses, among other things, a system and method for communicating emergency or monitoring information using a short range (SR) portable device and a long range (LR) communication network at a reduced cost, or at no cost, to the user.

In one embodiment, the present subject matter includes a first portable device adapted to transmit a wireless message compatible with a communication standard such as BLUETOOTH®, HomeRF™ or the Institute of Electrical and Electronic Engineers (IEEE) § 802. The wireless message, which may include an emergency message or other message, is propagated wirelessly over a SR and received by a second device. The second device receives the message and decodes a priority code of the message to determine if the message is to be routed further. In one embodiment, the second device is adapted to access a LR communication network. As a function of a message destination transmitted from the first portable device, the second device propagates the message using the LR communication network. The LR communication network may include a cellular telephone network.

The present subject matter allows a user with a SR transmitter to propagate a message over a LR communication network by communicating with a compatible receiver also coupled to the LR communication network. In one embodiment, the SR transmitter sends a priority code to allow the message to be propagated on the LR communication network to a predetermined destination without incurring network communication fees. In one embodiment, the destination is treated as a priority code denoting that the message is approved and access to the LR communication network is authorized. In one embodiment, the message is propagated without checking credit or validation of a LR communication network account. In one embodiment, a fee is charged for use of the LR communication network and the account is credited in an amount equal to or less than the fee for the use of the LR communication network. In one embodiment, the message is discarded and not delivered if the destination is not approved.

In one embodiment, the message relates to an emergency condition or to the health, safety or welfare of a monitored individual. The present subject matter relates to systems and methods for providing emergency monitoring of a user which may include an adult or child and in one embodiment, includes patients. In one embodiment, the portable device is worn or carried by the monitored individual. The portable device may include an implanted device, a cellular telephone, a pager device, a personal data assistant (PDA), a handheld computer or other device. In one embodiment, the portable device allows bi-directional communications with a monitor center over a voice, video or data communication channel.

A database accessible to the monitor center includes information corresponding to the portable device or a designated user of the portable device. Contents of the database includes, for example, identification and contact information for an authority or guardian of the designated user. In addition, the database may include health or medication information for the designated user.

A message transmitted from the portable device may include an authorization, or request, to access the database. For example, the message may include a request for medical services and the database contents includes primary physician contact information or prescription information. The information may be relayed by the monitor center to the primary physician or to an emergency medical technician.

Other aspects of the invention will be apparent on reading the following detailed description of the invention and viewing the drawings that form apart thereof.

### BRIEF DESCRIPTION OF THE DRAWINGS

In the drawings, like numerals describe substantially similar components throughout the several views. Like numerals having different letter suffixes represent different instances of substantially similar components.

FIG. 1 includes a schematic illustrating a portable device and selected communication elements.

FIG. 2 includes a schematic illustrating routing of a message according to one embodiment of the present subject matter.

FIG. 3 includes a schematic illustrating routing of a message according to one embodiment of the present subject matter.

### DETAILED DESCRIPTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural, logical and electrical changes may be made without departing from the spirit and scope of the present invention. The following detailed description is, therefore, not to be taken in a limiting sense, and the scope of the present invention is defined by the appended claims and their equivalents. In the drawings, like numerals describe substantially similar components throughout the several views. Like numerals having different letter suffixes represent different instances of substantially similar components.

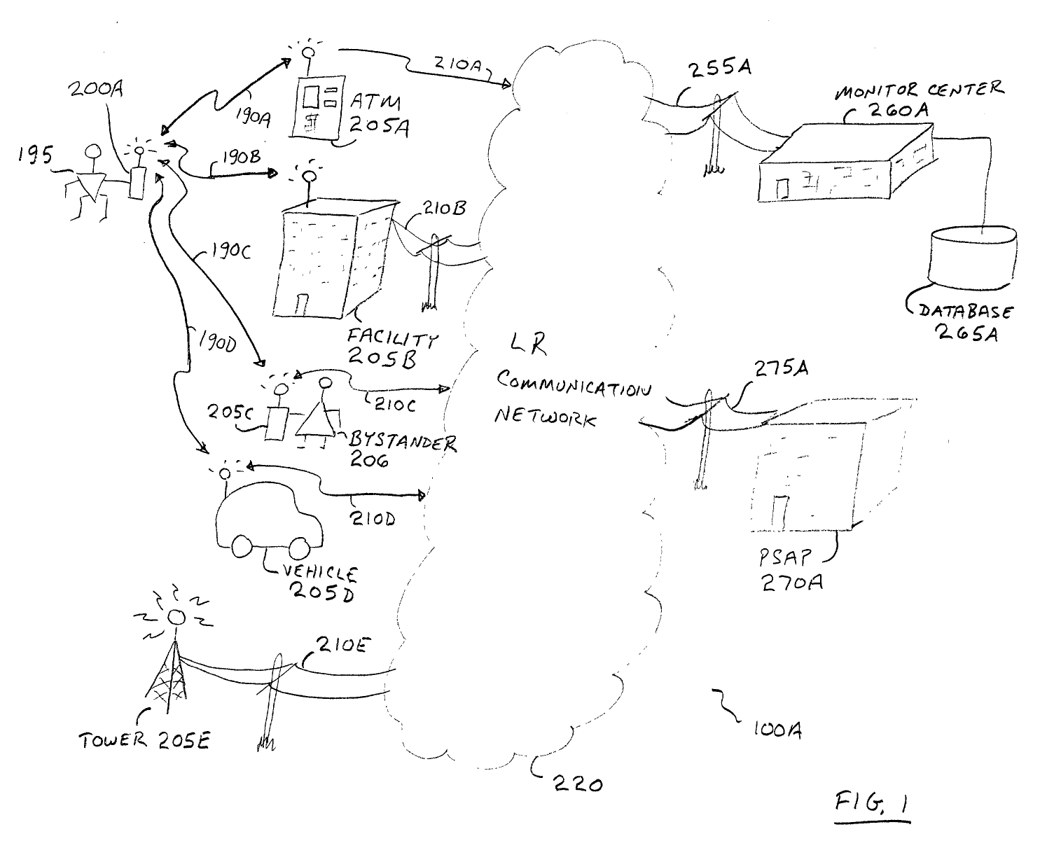

FIG. 1 illustrates system 100A including portable device 200A, monitor center 260A, public safety answering point (PSAP) 270A as well as other elements adapted for communicating using LR communication network 220.

In the figure, automatic teller machine (ATM) 205A includes a SR wireless transceiver adapted for wirelessly communicating with nearby devices. In addition, ATM 205A includes data connection or link 210A coupled to communication network 220. Data connection 210A may include a dial-up modem coupled to a telephone line, a cable modem, a digital subscriber line (DSL)modem, an Ethernet connection or other wired or wireless network connection.

In one embodiment, ATM 205A is equipped with a BLUETOOTH® transceiver and a modem configured for a dial-up telephone connection to a local area network(LAN) or wide area network (WAN) such as the Internet. The wireless message from device 200A is received by ATM 205A and thereafter propagated as ane-mail message using the LAN or WAN for delivery over the long range communication network to monitor center 260A.

In one embodiment, a SR wireless transceiver includes a transceiver compatible with BLUETOOTH®, HomeRF™ or IEEE § 802. In addition to high frequency radio communications, other types of SR wireless transceivers are also contemplated.

BLUETOOTH®(is a trademark registered by Telefonaktiebolaget LM Ericsson of Stockholm, Sweden and refers to SR communication technology developed by an industry consortium known as the BLUETOOTH®Special Interest Group. BLUETOOTH® operates at a frequency of approximately 2.45 GHz, utilizes a frequency hopping (on a plurality of frequencies) spread spectrum scheme, and provides a digital data transfer rate of approximately 1 Mb/second. BLUETOOTH® transceivers have a range of approximately 10 to 100 meters (and sometimes more) and by combining several BLUETOOTH® transceivers in an ad-hoc network, the communication range can be extended indefinitely. The communication range can also be extended by coupling a BLUETOOTH® transceiver with a second transceiver coupled to a LR network, such as a cellular telephone network or pager network. One standard suitable for the present subject matter includes BLUETOOTH® version 1.0, however later or earlier standards may also be used.

In addition to BLUETOOTH®, the present subject matter is operable using other SR wireless communication protocols including HomeRF™ and certain of the standards promulgated by the IEEE under § 802, including for example, §§802.11, 802.15 and 802.16. The IEEE 802.15 WPAN standard is anticipated to include the technology developed by the BLUETOOTH® Special Interest Group. WPAN refers to Wireless Personal Area Networks. The IEEE 802.15 WPAN standard is expected to define a standard for wireless communications within a personal operating space (POS) which encircles a person.

Facility 205B includes a SR wireless transceiver, also adapted to allow wireless communications with nearby devices. Furthermore, facility 205B, which may be a commercial or residential building or other facility, includes data connection 210B. As with ATM 205A, data connection 210B may include a dial-up modem coupled to a telephone line, a cable modem, a digital subscriber line (DSL) modem, an Ethernet connection or other wired or wireless network connection. In addition, data connection 210B may include an interface coupled to the PSTN.

Device 205C includes a SR wireless transceiver, also adapted to allow wireless communications with nearby devices. Device 205C is adapted for portable operation and may be worm, or carried by, bystander 206. Device 205C further includes a wireless LR transceiver adapted to couple with a wireless network for data or voice. For example, in one embodiment, link 210C denotes a wireless cellular telephone connection. Link 210C may include a pager communication link, a wireless Internet connection or a wireless network connection.

In one embodiment, device 205C enjoys a trusted status relative to portable device 200A. A trusted status, in the context of BLUETOOTH® denotes that device 205C will accept and process wireless communications from device 200A. The trust relationship may be established manually or by other means and affords device 200A with access to resources enjoyed by device 205C. In the event that device 205C trusts device 200A, then a message received by device 205C can be propagated on the LR communication network accessible to device 205C.

In one embodiment, device 205C does not enjoy a trusted status relative to portable device 200A. Absence of a trusted status, in the context of BLUETOOTH® denotes that device 205C will not accept and process wireless communications from device 200A. Thus, device 200A is denied access to resources accessible to device 205C. In one embodiment, a priority code present in the wireless message from device 200A is received and interpreted by device 205C to denote that the message is of such importance that compliance with trust requirements is waived and the message is propagated using a network resource accessible to device 205C. The priority code, in one embodiment, denotes an emergency message. In one embodiment, the priority code includes a field of data (one or more bits) in the packet header or set up channels of the service discovery protocol. The priority code indicates that the message is being propagated to a destination already determined to be authorized. The determination of authorization for the destination may be done by way of a look up table at device 205C or by accessing a database via LR communication network 220 to determine destination authorization. The destination is authorized to preclude access to unauthorized destinations. For example, authorized destinations may include medical, police, fire and related services and facilities and an unauthorized destinations may include a grocery store.

Vehicle 205D includes a SR wireless transceiver, also adapted to allow wireless communications with nearby devices. Vehicle 205D may include, for example, a wireless security system based on a BLUETOOTH® communication protocol. In addition, vehicle 205D includes LR wireless link 210D. Link 210D includes, in various embodiments, a wireless cellular telephone connection, a pager communication link, a wireless Internet connection or a wireless network connection.

Tower 205E is adapted for LR wireless communications. In one embodiment, tower 205E is interfaced to a PSTN, or other communication network, by link 210E. Tower 205E is adapted for wireless cellular telephone communications, pager communications, trunked radio communications or other LR communications. In one embodiment, tower 205E is adapted to communicate with a LR wireless transceiver of ATM 205A, facility 205B, device 205C or vehicle 205D.

Monitor center 260A is coupled to LR communication network 220 by link 255A. LR communication network 220 may include a PSTN, a digital data network, an intranet, or the Internet. In one embodiment, monitor center 260A is adapted to provide an acknowledgment signal to indicate receipt of a request for emergency services.

Monitor center 260A, in one embodiment, includes, or has access to, database 265A. Database 265A includes account information, medical information, contact information and preference information for designated user 195 of device 200A. For example, in one embodiment, the contents of database 265A includes contact information for a predetermined guardian of designated user 195. Contact information may include an e-mail address, a telephone number, a pager number, trunked radio channel information, a facsimile telephone number, residence or business street address as well as other information. In addition, database 265A may include health and medical information, including dosages and schedules for prescription medicines, physician identification, insurance information and contact information as well as individual or family medical history tailored for a particular designated user.

Public safety answering point (PSAP) 270A is coupled to LR communication network 220 by link 275A. PSAP 270A may be operated by a governmental or non-governmental entity and is tailored to render emergency services, including dispatching of police, fire and emergency medical responders. PSAP 270A is adapted to receive requests for emergency services via LR communication network 220. PSAP 270A is also adapted to communicate with monitor center 260A. In one embodiment, PSAP 270A is adapted to provide an acknowledgment signal to indicate receipt of a request for emergency services.

Consider the operation of system 100A illustrated in FIG. 1. From device 200A, a wireless SR transmission is broadcast. The transmitted message may relate to a real or perceived emergency situation or condition and may be triggered by a measured parameter, detected event or by user activation. For example, in the event that a measured temperature exceeds a predetermined value, or an acceleration is detected, or a user operable keystroke is detected, a wireless message is broadcast from device 200A. The broadcast message may include data concerning the measured parameter, detected event or user activation. In one embodiment, the message includes data or a verbal script.

If the wireless message transmitted from device 200A is received by nearby vehicle 205D, then, for example, in one embodiment, the message is propagated using LR communication network 220 via link 210D. Link 210D may include a cellular, or other antenna, tower as shown at 205E. Tower 205E is further coupled to LR communication network 220 via link 210E. By way of summary, the message from device 200A is propagated to LR communication network 220 for eventual delivery and routing to either or both of monitor center 260A and PSAP 270A.

In one embodiment, vehicle 205D is traveling in the vicinity of the location of device 200A and during the time in which vehicle 205D is within SR communication range of device 200A, the message from 200A is transmitted to vehicle 205D. Simultaneously, or after a short or long delay, vehicle 205D propagates the message using the wireless LR communication transceiver.

In one embodiment, the message transmitted from device 200A includes location information. In one embodiment, device 200A includes a location module having internal circuitry or programming to determine the geographical location of device 200. For example, in one embodiment, device 200A includes a global positioning satellite (GPS) receiver, a LORAN receiver or other location determining hardware and software. In one embodiment, location information is determined by means of timing or other exchanged signals with a communication network. In one embodiment, location information is determined by a combination of hardware and software resident in device 200A and services provided by the communication network.

In one embodiment, location information is derived from a nearby location module accessible to device 200A. For example, a location module may be available at ATM 205A, facility 205B, device 205C or vehicle 205D. In such cases, the location information provided with the message denotes the location of a nearby position and thus provides approximate location information for device 200A. In one embodiment, the origin, or accuracy, of any transmitted location information is denoted in the wireless message.

In one embodiment, the message includes a priority code tailored to designate that communications conducted using the LR communication network are to proceed without delay or without incurring expenses associated with accessing the communication services. For example, in placing a telephone call using a cellular telephone, air time charges are normally incurred and payable by the cellular telephone account holder. In the present subject matter, for example, vehicle 205D propagates the message using cellular telephone service and the priority code of the message denotes that the cellular telephone call is to be transmitted at no cost to the cellular telephone account holder associated with vehicle 205D. In one embodiment, the priority code indicates that the call is to proceed without checking validation or credit of the cellular telephone account holder. In one embodiment, validation and credit of the cellular telephone account holder is established and costs are incurred but are subsequently negated by an accounting measure triggered by the priority code of the message. In one embodiment, the cellular telephone account holder, or an account holder associated with device 200A, incurs a portion of the billing attributable to the propagation of the message.

In one embodiment, the message destination, encoded in the message, serves as the priority code. If the destination is an approved destination, then the message is propagate through the LR communication network without delay or further checking or verification of a service account.

Messages, each bearing one or more approved destinations selected from a group of approved destinations, may be propagate through LR communication network 220 without tolls, checking validation or credit. For example, an approved destination may include a selected police station, fire department or hospital facility. In one embodiment, many such facilities are approved and the geographical routing of emergency messages is performed by one or more routers coupled to the LR communication network. Routing may also be performed to expedite delivery of requested emergency services according to the need expressed in the message.

In one embodiment, LR communications are conducted using packetized data transmission. In such cases, expenses chargeable to the account holder and incurred in the transmission of the data packets for the message, are waived, nullified, reduced or otherwise negated.

In one embodiment, the propagation of the message involves multiple receptions and transmissions using multiple devices. For example, assume that the message transmitted by device 200A is received at ATM 205A and that LR link 210A is not currently available. In this case, ATM 205A may assist in propagating the message by forwarding the message to another nearby device with a compatible transceiver. For example, ATM 205A may forward the message to facility 205B and facility 205B may then propagate the message using LR communication network 220 and link 210B.

Multiple BLUETOOTH® transceivers can operate as an ad-hoc network in which each transceiver is aware of other transceivers within a particular range. Assuming ATM 205A, bystander with device 205B and vehicle 205C are within wireless range, then an ad-hoc network may be established. The message can be propagated over a greater distance using multiple ad-hoc networks.

The message may be received by any of one or more compatible receivers, such as, for example, ATM 205A, facility 205B, compatible device 205C of bystander 206, nearby vehicle 205D or tower 205E. Each of ATM 205A, facility 205B, compatible device 205C, nearby vehicle 205D and tower 205E are in communication with LR communication network 220. For example, ATM 205A, facility 205B, compatible device 205C, nearby vehicle 205D and tower 205E are coupled to LR communication network 220 by links 210A, 210B, 210C, 210D and 210E, each of which may be a wired or wireless connection.

Monitor center 260A and PSAP 270A, are both also coupled to LR communication network 220 via links 255A and 275A, respectively. It will be appreciated that links 210A, 210B, 210C, 210D, 210E, 255A and 275A may include wired connections or wireless links, including for example, optical connections, radio frequency connections or other connections.

The LR communication capabilities of ATM 205A, facility 205B, device 205C, vehicle 205D, tower 205E or other such device may be busy at a time when a message is to be transmitted on behalf of user 195. For example, bystander 206 may be engaged in a telephone call (using device 205C) or data communications may be occurring with ATM 205A. In such a case, one embodiment of the present subject matter includes programming to put the cellular telephone in an “on-hook” condition followed shortly thereafter by initiating a new telephone call to monitor center 260A or PSAP 270A service. By seizing the telephone line in this manner, the telephone call of bystander 206 is dropped and the emergency call is placed. In one embodiment, the emergency call can be placed without first terminating an ensuing telephone call of bystander 206. Bystander 206 may be unaware that the message is being transmitted. The message, as well as any ensuing telephone conversation of bystander 206, may be multiplexed with digitized packets representing the emergency call interspersed with digitized packets representing the bystander's telephone call. A cellular telephone operating using General Packet Radio Service (GPRS) protocol is capable of such multiplexed communication. In one embodiment, communications are conducted using a protocol compatible with 1× RTT (radio transmission technology) specification. 1× RTT is an international third generation (3G) wireless network standard evolved from CDMA (Code Division Multiple Access) networks which enables high-speed wireless access from laptops, handheld computers and Internet appliances to enterprise applications, streaming audio, video and the Internet.

Other schemes to accommodate a situation where bystander 206 is engaged in a telephone call at a time when a message is to be transmitted are also contemplated. For example, in one embodiment, the pre-existing telephone call is automatically terminated (with or without notification to bystander 206) and access to the telephone transceiver is seized. In one embodiment, the signal is unobtrusively propagated to a subsequent bystander, or other nearby device, for further propagation. Other configurations are also contemplated.

Portable device 200A may generate and transmit a signal based on user input, based on a schedule, or based on a predetermined detected event or measured parameter. The user input may be manually entered using one or more buttons or entered using voice recognition.

In addition to BLUETOOTH®, portable device 200A, as well as bystander devices, may include transceivers compatible with HomeRF™ or IEEE 802.11 transceiver or other wireless technology. In one embodiment, portable device 200A includes a processor with memory and executes a suitable program to support the different functions described herein. For example, BLUETOOTH®-compatible devices are generally self-aware in that each device executes an automatic routine to identify other nearby compatible devices.

In one embodiment, when user 195 experiences a medical emergency, device 200A carried by the user transmits a wireless message. The message includes the user's location as well as detail information concerning the medical emergency. The message is broadcast using a SR transceiver of device 200A. The transmitted signal is received by one or more nearby compatible devices that form one or more ad-hoc communication networks. If one of the receivers of an ad-hoc network includes a LR transmitter, then that receiver will re-transmit, or propagate, the message using the LR communication network. If no receiver in the ad-hoc network includes a LR transmitter, then each receiver will propagate a SR transmission until a LR transmitter is found. The signal will be successively received and re-transmitted until the signal is received by monitor center 260A. At monitor center 260A, the wireless message is correlated with data specific to the user, based on a source identifier encoded with the message. Monitor center 260A, based on the database of information for the user and the received emergency message, then sends an emergency request to a PSAP (such as 270A) or other emergency authority.

In one embodiment, a confirmation, acknowledgment or verification signal is returned to user 195 to indicate that the emergency message was successfully received by the monitor center, PSAP, intermediate SR communication device or LR communication network element. In one embodiment, an acknowledgment signal is returned for any transmitted emergency message. The acknowledgment signal may confirm that an intermediate recipient is able to forward the message via a network connection. Other acknowledgment signals are also contemplated. For example, in various embodiments, acknowledgment signals can be used to confirm that the message has been received, that the receiving device has access to a network (either SR or LR), that the receiving device has forwarded the message or that the message destination has received the message and has responded.

In one embodiment, the wireless message includes information concerning a particular condition experienced by user 195. For example, the information may indicate that the user is currently experiencing a medical emergency or personal emergency. The transmitted wireless signal is broadcast to one or more nearby compatible receivers using a SR transceiver.

In one embodiment, device 200A includes a BLUETOOTH® transmitter. The transmitted wireless message includes suitable coding to cause a nearby receiver to promptly forward the message without substantial amendment of the message.

In various embodiments, the message is routed to monitor center 260A in the form of an e-mail message, a trunked radio message, a cellular telephone message, an instant message, or a short message (as provided by short message service, SMS). Thus, the LR transceiver may include a networked computer, a radio transceiver, a cellular telephone, a bi-directional pager or other LR communication device.

In one embodiment, portable device 200A is adapted for implantation in a living body. In one embodiment, the user device is adapted to be worn on the user's person in a manner similar to a garment or ornamentation. In one embodiment, the device is adapted to be carried by the user or placed in a position near the user.

The transmitted wireless message may include location information. In the event that the transmitted wireless message does not include location information, one embodiment provides that a nearby compatible receiver supply location information. In one embodiment, portable device 200A is configured for bi-directional communication (of audio or digital data) and monitor center 260A or PSAP 270A communicates with portable device 200A to provide services or receive location information entered by user 195.

The location information (if available), along with the transmitted wireless message, is relayed to monitor center 260A. Relaying may include one or more “hops” or signal transmissions. In one embodiment, the transmitted wireless message is initially propagated as a BLUETOOTH® compatible signal, and in a subsequent hop, may be transmitted as a cellular telephone signal. The cellular telephone signal may include a 911 emergency telephone call.

Location information may be generated using circuitry or programming executing internally within device 200A (such as for example, a GPS or LORAN device) or generated by means of receiving location information from other nearby devices (such as those within or near the ad-hoc network). In one embodiment, location information is derived from data exchanged using the communication network. In one embodiment, location information is provided by a first element of an ad-hoc network and the message is propagated using a second element of the ad-hoc network.

Monitor center 260A may receive emergency requests via the PSTN, a cellular telephone network, a pager communication network, a radio communication network, an e-mail notification or other means. In one embodiment, monitor center 260A maintains a database of service providers (including fire, police, medical, other) as well as a database of user accounts. The user accounts may include, for example, user identification information, medical information and contact or guardian information. Data from monitor center 260A is combined with the data from the message and routed to a PSAP service. In one embodiment, monitor center 260A forwards the message directly to PSAP 270A without processing or without accessing a database.

Long range communication network 220 may operate using a variety of communication protocols, including but not limited to, cellular telephone protocols, one-way or two-way pager protocols, and PCS protocols. Typically, PCS systems operate in the 1900 MHZ frequency range. One example, known as Code-Division Multiple Access (CDMA, Qualcomm Inc., one variant is IS-95) uses spread spectrum techniques. CDMA uses the full available spectrum and individual messages are encoded with a pseudo-random digital sequence. Another example, Global Systems for Mobile communications (GSM), is one of the leading digital cellular systems and allows eight simultaneous calls on the same radio frequency. Another example, Time Division Multiple Access (TDMA, one variant known as IS-136) uses time-division multiplexing (TDM) in which a radio frequency is time divided and slots are allocated to multiple calls. TDMA is used by the GSM digital cellular system. Another example, 3G, promulgated by the ITU (International Telecommunication Union, Geneva, Switzerland) represents a third generation of mobile communications technology with analog and digital PCS representing first and second generations. 3G is operative over wireless air interfaces such as GSM, TDMA, and CDMA. The EDGE (Enhanced Data rates for Global Evolution) air interface has been developed to meet the bandwidth needs of 3G. Another example, Aloha, enables satellite and terrestrial radio transmissions. Another example, Short Message Service (SMS), allows communications of short messages with a cellular telephone, fax machine and an IP address. Messages are limited to a length of 160 alpha-numeric characters. Another example, General Packet Radio Service (GPRS) is another standard used for wireless communications and operates at transmission speeds far greater than GSM. GPRS can be used for communicating either small bursts of data, such as e-mail and Web browsing, or large volumes of data.

In one embodiment, LR communication network 220 operates using one way or two way pager technology. Examples of one way pager protocols include Post Office Code Standardization Advisory Group (POCSAG), Swedish Format (MBS), the Radio Data System (RDS, Swedish Telecommunications Administration) format and the European Radio Message System (ERMES, European Telecommunications Standards Institute) format, Golay Format (Motorola), NEC-D3 Format (NEC America), Mark IV/V/VI Formats (Multitone Electronics), Hexadecimal Sequential Code (HSC), FLEX™ (Motorola) format, Advanced Paging Operations Code (APOC, Philips Paging) and others. Examples of two way pager protocols include ReFLEX™ (Motorola) format, InFLEXion™ (Motorola) format, NexNet™ (Nexus Telecommunications Ltd. of Israel) format and others.

Other LR communication protocols are also contemplated and the foregoing examples are not to be construed as limitations but merely as examples.

According to one definition, and subject to the vagaries of radio design and environmental factors, SR may refer to systems designed primarily for use in and around a premises and thus, the range generally is below a mile. Short range communications may also be construed as point-to-point communications, examples of which include those compatible with protocols such as BLUETOOTH®, HomeRF™, and IEEE § 802. Long range, thus, may be construed as networked communications with a range in excess of short-range communications. Examples of LR communication may include, Aeris MicroBurst cellular communication system, and various networked pager, cellular telephone or, in some cases, radio frequency communication systems.

Alternatives

In one embodiment, other means of LR communications are also contemplated. For example, in one embodiment, the long distance communication may be compatible with a Wireless Application Protocol (WAP) signal or a Short message Service (SMS) protocol. Other embodiments are also contemplated, including but not limited to, for example, Transmission Control Protocol (TCP), or Internet Protocol (IP) or TCP/IP.

In one embodiment, the SR message is transmitted from portable device 200A and encoded using a protocol compatible with BLUETOOTH®. In one embodiment, the BLUETOOTH® message includes a destination identifier. In one embodiment, the SR message is converted from a BLUETOOTH® message into a communication protocol compatible with a LR transmission. A processor of the bystander's device, such as 205C, executes a program to identify any available LR communication module. A processor of the device 205C executes a program to convert the SR protocol into a LR protocol. In one embodiment, a processor determines what LR protocol is available and if no LR protocol is readily available, then device 205C forwards the message to a second nearby device. The second nearby device, such as found at facility 205B, executes a program to determine what LR communication protocol is available. The process of receiving a SR communication, checking for availability of a LR protocol and forwarding to another bystander if not found, is repeated until a LR protocol is found or the emergency message is communicated to either monitor center 260A or PSAP 270A. In one embodiment, the nearby device, equipped to access a LR protocol, then transmits a LR signal. The LR signal then is routed to monitor center 260A based on the destination identifier.

In one embodiment, the message transmitted by portable device 200A, or one or more bystander devices, includes an embedded override code adapted to defeat a security system of the one or more bystander devices. For example, in certain bystander devices, an incoming transient message is normally received using BLUETOOTH® and re-broadcast also using BLUETOOTH®. Access to the LR transceiver is restricted to particular programmed functions in some cases, because LR transmissions may be fee-based. In the present subject matter a suitably programmed incoming message is received by BLUETOOTH® transceiver and re-transmitted using the LR transceiver. Access to the LR transceiver portion of the bystander device is predicated on receiving a predetermined authorization code embedded in the message.

In the present subject matter, outgoing messages to monitor center 260A or PSAP 270A are transmitted at no cost to the service account accessed by the bystander's device. For example, an emergency call placed to 911 is transmitted at no cost to the bystander's service account. In similar manner, a message according to the present subject matter is transmitted at no cost to the bystander's service account. In one embodiment, the predetermined telephone or access number for monitor center 260A is programmed to be a no-cost telephone call. In one embodiment, any costs incurred to the bystander's service account are credited back to result in no net cost to the bystander. In one embodiment, the predetermined telephone or access number is registered with the network and each device in the system is authorized to call the number at no cost.

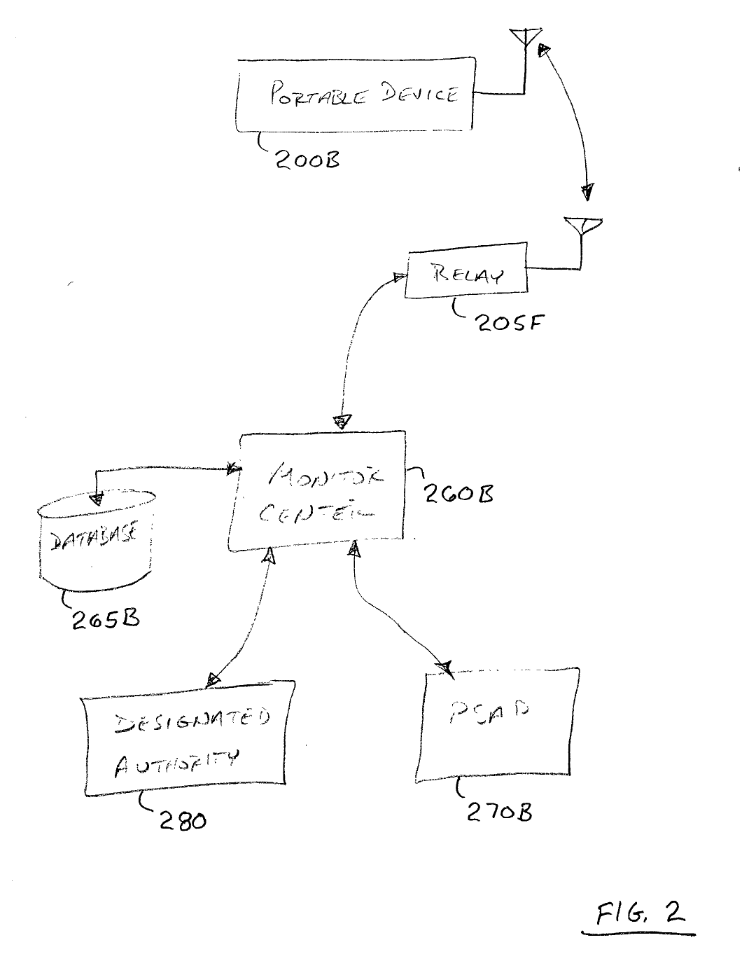

FIG. 2 illustrates routing of a message according to one embodiment of the present subject matter. In the figure, portable device 200B communicates wirelessly, over a SR link, with relay 205F. Relay 205F, in one embodiment, includes a nearby compatible wireless device having access to monitor center 260B via a LR communication network such as network 220. The link between relay 205F and monitor center 260B may be wired or wireless, and relay 205F may incur no cost or a reduced cost in establishing the communication link. Upon receiving the message, monitor center 260B accesses database 265B and retrieves contact information, medical history, or other information based on the context of the received message. Also, depending on the context of the received message, monitor center 260B determines if the appropriate response includes contacting designated authority 280, PSAP 270B, or both designated authority 280 and PSAP 270B. For example, if the message is of pedestrian nature, then monitor center 260B may opt to contact designated authority 280 and if the message is of a life threatening nature, then contact PSAP 270B. In the event of ambiguity, or on particular instructions, both designated authority 280 and PSAP 270B are contacted in simultaneous or serial fashion.

Designated authority 280 or PSAP 270B, having established communications with monitor center 260B, may request receipt of additional information derived from database 265B. In addition, either designated authority 280 or PSAP 270B may request to establish bi-directional communications with a user of portable device 200B. Bi-directional communications may proceed using relay 205F or other available communication channel.

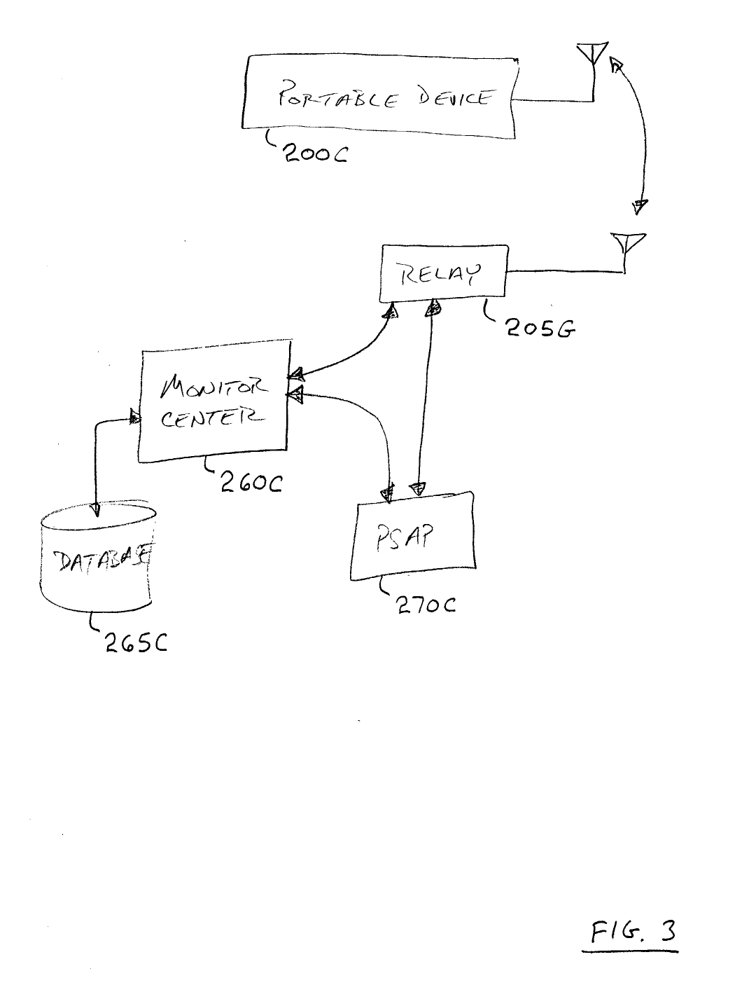

FIG. 3 illustrates routing of a message according to one embodiment of the present subject matter. In the figure, portable device 200C communicates wirelessly, over a SR link, with relay 205G. Relay 205G, in one embodiment, includes a nearby compatible wireless device having access to either monitor center 260C, PSAP 270C, or both monitor center 260C and PSAP 270C via a LR communication network such as network 220. The link between relay 205G and monitor center 260C, or between relay 205G and PSAP 270C, may be wired or wireless, and relay 205G may incur no cost or a reduced cost in establishing the communication link. Upon receiving the message, monitor center 260C accesses database 265C and retrieves contact information, medical history, or other information based on the context of the received message. Also, depending on the context of the received message, monitor center 260C determines if the appropriate response includes contacting a designated authority. In one embodiment, relay 205G communicates directly with PSAP 270C and PSAP 270C may elect to request database information from database 265C via monitor center 260C. In one embodiment, authorization to access database 265C is provided in the message received by PSAP 270C. In addition, PSAP 270C may request to establish bi-directional communications with a user of portable device 200C. Bi-directional communications may proceed using relay 205G or other available communication channel.

In one embodiment, the contents of database 265A are updated based on the contents of the emergency message.

In one embodiment, a processor is coupled to a short range wireless transceiver and the LR communication device. The processor includes programming to analyze a priority code or destination identifier to determine if the message should be routed to the destination using the LR communication network. In one embodiment, the processor analyzes the destination to determine if a toll free call should be allowed to proceed. In the event that the destination is not approved, or approval cannot be verified by accessing a database coupled to the LR communication network, then the message is not propagated.

### CONCLUSION

The systems and methods disclosed in this document are adapted to facilitate emergency and monitoring communications. The above description is intended to be illustrative, and not restrictive. Many other embodiments will be apparent to those of skill in the art upon reviewing the above description.

What is claimed is:

1. A method comprising:
sending a message having an identifier, a priority code and a destination from a first short range wireless transceiver;
receiving the message at a second short range wireless transceiver;
if the priority code is approved,
forwarding the message to a long range communication device coupled to the second short range wireless transceiver;
if the destination is approved, transmitting the message to the destination using a long range communication network accessible to the long range communication device and without incurring a fee to a service account associated with the long range communication device; and
if the destination is not approved, not transmitting the message to the destination.

2. The method of claim 1 further comprising, if the priority code is not approved, denying access to the long range communication device.

3. The method of claim 1 wherein determining if the destination is approved includes accessing a look up table.

4. The method of claim 1 wherein transmitting the message includes sending a cellular telephone transmission.

5. The method of claim 1 wherein transmitting the message includes sending a pager message.

6. The method of claim 1 wherein transmitting the message includes sending an e-mail message.

7. The method of claim 1 wherein sending the message includes sending location information.

8. The method of claim 1 wherein transmitting the message includes transmitting location information.

9. The method of claim 1 further comprising accessing stored data corresponding to the first short range wireless transceiver.

10. The method of claim 1 further comprising receiving an acknowledgment signal at the first short range wireless transceiver.

11. The method of claim 1 further comprising transmitting an acknowledgment signal from the second short range wireless transceiver.

12. The method of claim 1 further comprising transmitting an acknowledgment signal from the destination.

13. The method of claim 1 further comprising:
accessing stored data based on the identifier;
generating a request based on the stored data and the message; and
sending the request.

14. A method comprising:
sending a message having an identifier and a destination from a first short range wireless transceiver;
receiving the message at a second short range wireless transceiver;
if the destination is approved, transmitting the message to the destination using a long range communication device coupled to the second short range wireless transceiver and without incurring a fee to a service account associated with the long range communication device; and
if the destination is not approved, not transmitting the message to the destination.

15. The method of claim 14 further comprising, if the destination is not approved, discarding the message.

16. The method of claim 14 wherein determining if the destination is approved includes accessing a look up table.

17. The method of claim 14 wherein transmitting the message includes sending a cellular telephone transmission.

18. The method of claim 14 wherein transmitting the message includes sending a pager message.

19. The method of claim 14 wherein transmitting the message includes sending an e-mail message.

20. The method of claim 14 wherein sending the message includes sending location information.

21. The method of claim 14 wherein transmitting the message includes transmitting location information.

22. The method of claim 14 further comprising receiving an acknowledgment signal at the first short range wireless transceiver.

23. The method of claim 14 further comprising transmitting an acknowledgment signal from the second short range wireless transceiver.

24. The method of claim 14 further comprising transmitting an acknowledgment signal from the destination.

25. The method of claim 14 further comprising:
accessing stored data based on the identifier;
generating a request based on the stored data and the message; and
sending the request.

26. The method of claim 25 wherein accessing stored data based on the identifier includes accessing data corresponding to the first short range wireless transceiver.
